(19) United States
(12) Patent Application Publication
(10) Pub. No.: US 2011/0063750 A1
(43) Pub. Date: Mar. 17, 2011

(54) SYSTEM AND METHOD TO CONTROL SPIN-UP OF STORAGE DEVICE

(75) Inventors: In-su Kim, Suwon-si (KR); Walter Jun, Seoul (KR)

(73) Assignee: Samsung Electronics Co., Ltd., Suwon-si (KR)

(21) Appl. No.: 12/881,488

(22) Filed: Sep. 14, 2010

(30) Foreign Application Priority Data
Sep. 15, 2009 (KR) 10-2009-0086936

(51) Int. Cl. G11B 15/18

(52) U.S. Cl. 360/71; G9B/15.021

(57) ABSTRACT

A storage device spin-up control system includes a storage device to store data, a host to selectively control a spin-up mode of the storage device, and an interface to link the storage device and the host. The host controls the spin-up mode of the storage device based on a level of a signal output from a power connector of the interface. Thus, spin-up failure of the storage device due to insufficient power supply from the host may be prevented.

### CROSS-REFERENCE TO RELATED APPLICATIONS

This application claims the benefit under 35 U.S.C. §119(a) of Korean Patent Application No. 10-2009-0086936, filed on Sep. 15, 2009, in the Korean Intellectual Property Office, the disclosure of which is incorporated herein in its entirety by reference.

### BACKGROUND

1. Field of the Invention

The present general inventive concept relates to a storage device spin-up control system and method, and more particularly, to a system and method of selectively controlling a spin-up mode of a storage device based on the level of a signal output from a power connector.

2. Description of the Related Art

Storage devices such as hard disk drives (HDD) have been widely used in a variety of digital devices, including desktop personal computers and laptop computers. However, with the wider use of such storage devices, spin-up failure frequently occurs due to insufficient power supply from a host or variations in power supply, and thus a storage device is more likely to not be recognized. A spin-up failure is a failure of the hard disk to achieve a rotation velocity sufficient to perform a read/write operation from/to the hard disk. In order to address these problems, various methods of successfully spinning up a storage device in connection with a host supplying insufficient power by using firmware have been applied. However, the storage device may not be able to obtain information on power supplied from the host, and thus may not be able to determine which of methods may be applicable to a host.

### SUMMARY

The present general inventive concept selectively controls a spin-up mode of a storage device based on the level of a signal output from a power connector of an interface linking a host and the storage device.

Additional features and utilities of the present general inventive concept will be set forth in part in the description which follows and, in part, will be obvious from the description, or may be learned by practice of the general inventive concept.

Features and/or utilities of the present general inventive concept may be realized by a storage device spin-up control system including a storage device to store data, a host to selectively control a spin-up mode of the storage device, and an interface to link the storage device and the host. The host may control the spin-up mode of the storage device based on a level of a signal output from a power connector of the interface.

The host may include a power connector signal level detection unit that detects the level of the signal output from the power connector and outputs a corresponding signal.

The host may include a current control unit that controls the spin-up mode of the storage device based on the level of the signal detected by the power connector signal level detection unit.

The current control unit may spin up the storage device in a normal current mode if the signal output from the power connector level detection unit is at a first logic level, and may spin up the storage device in a low current mode if the signal output from the power connector level detection unit is at a second logic level.

The power connector signal level detection unit may include a first detection unit to detect a maximum current that can be supplied from the host to spin up the storage device, a second detection unit to detect a threshold current required for the storage device to spin up, a comparison unit to compare the maximum current detected by the first detection unit and the threshold current detected by the second detection unit, and an output unit to output a signal corresponding to the level of the signal of the power connector at a first logic level if the maximum current is greater than the threshold current, and to output a signal corresponding to the level of the signal of the power connector at a second logic level if the maximum current is less than the threshold current.

The host may include an automatic mode switching unit that determines whether the storage device has been successfully spun up by using a current supplied from a power supply unit of the host, and that controls the spin-up mode of the storage device based on the level of the signal output from the power connector exclusively when the storage device fails to spin up.

The storage device spin-up control system may further include a manual mode switching unit, and the host may control the spin-up mode of the storage device exclusively when the manual mode switching unit is selected by a user.

The host may spin up the storage device in a normal current mode if the manual mode switching unit is not selected by the user, and the host may spin up the storage device in a low current mode if the manual mode switching unit is selected by the user.

The manual mode switching unit may include an external switch located outside the host.

The interface may include a Serial Advanced Technology Attachment (SATA) interface, and the power connector may include a power pin 11 of the SATA interface.

Features and/or utilities of the present general inventive concept may also be realized by a storage device spin-up control system including N storage devices to store data, where N is a natural number of 2 or greater, a host to selectively control spin-up modes of the N storage devices, and an interface to link the N storage devices and the host. The host may include a staggered spin-up (SSU) control unit to control sequentially spinning up of the N storage devices, and the host may control the spin-up modes of the N storage devices based on a level of a signal output from a power connector of the interface.

The host may include a power connector signal level detection unit that detects the level of the signal output from the power connector and outputs a corresponding signal.

The host may include a current control unit that controls a spin-up mode of an n^{th} storage device based on the level of the signal detected by the power connector signal level detection unit, where n is a natural number from 1 to N used to denote one of the N storage devices.

The current control unit may spin up the n^{th} storage device in a normal current mode if the signal output from the power connector level detection unit is at a first logic level and may spin up the n^{th} storage device in a low current mode if the signal output from the power connector level detection unit is at a second logic level.

Features and/or utilities of the present general inventive concept may also be realized by a storage device spin-up control method including linking a host and a storage device, detecting a level of a signal output from a power connector of an interface linking the host and the storage device, and controlling a spin-up mode of the storage device based on the detected level of the signal.

The controlling of the spin-up mode of the storage device may include spinning up the storage device in a normal current mode if the signal output from the power connector is at a first logic level and spinning up the storage device in a low current mode if the signal output from the power connector is at a second logic level.

The detecting of the level of the signal may include detecting a maximum current that can be supplied from the host to spin up the storage device, detecting a threshold current required for the storage device to spin up, comparing the maximum current and the threshold current, and outputting a signal corresponding to the level of the signal output from the power connector at a first logic level if the maximum current is greater than the threshold current and outputting a signal corresponding to the level of the signal output from the power connector at a second logic level if the maximum current is less than the threshold current.

Features and/or utilities of the present general inventive concept may also be realized by a storage device spin-up control method including controlling sequential spinning up of N storage devices, where N is a natural number of 2 or greater, linking a host and an n^{th} storage device, where the n^{th} storage device is one of the N storage devices and n is a natural number from 1 to N, detecting a level of a signal output from a power connector of an interface linking the host and the N storage devices, and controlling a spin-up mode of the n^{th} storage device based on the detected level of the signal.

The controlling of the spin-up mode of the n^{th} storage device may include spinning up the nth storage device in a normal current mode if the signal output from the power connector is at a first logic level, and spinning up the n^{th} storage device in a low current mode if the signal output from the power connector is a second logic level.

The detecting of the level of the signal may include detecting a maximum current that can be supplied from the host to spin up the N storage devices, detecting a threshold current required for the n^{th} storage device of the N storage devices to spin up, comparing the maximum current and the threshold current of the n^{th} storage device, and outputting a signal corresponding to the level of the signal output from the power connector at a first logic level if the maximum current is greater than the threshold current required for the n^{th} storage device to spin up and outputting a signal corresponding to the level of the signal of the power connector at a second logic level if the maximum current is less than the threshold current required for the n^{th} storage device to spin up.

Features and/or utilities of the present general inventive concept may also be realized by a data storage device including a hard disk drive and a hard disk drive control unit to control a spin-up operation of the hard disk drive. The hard disk drive control unit may supply a first current to the hard disk drive to perform a first spin-up operation when a detected power level to the hard disk drive is a first level, and the hard disk drive control unit may supply a second current less than the first current to the hard disk drive to perform a second spin-up operation when a detected power level to the hard disk drive is a second level less than the first level.

The hard disk drive control unit may include a power supply unit to supply power to the hard disk drive to perform the spin-up operation, a current control unit to supply the first and second current to the hard disk drive, and a power level detection unit to detect the power level supplied to the hard disk drive.

The power level detection unit may include a first detection unit to detect a threshold current level required by the hard disk drive to perform the first spin-up operation, a second detection unit to detect the power level supplied to the hard disk drive, a comparison unit to compare a power level corresponding to the current level detected by the first detection unit and the power level supplied to the hard disk drive, and an output unit to output a power level detection signal to the current control unit.

The output unit may output the power level detection signal on a connection pin of the hard disk drive control unit that is used to control a staggered spin-up of the hard disk drive.

Features and/or utilities of the present general inventive concept may also be realized by a computing device including a hard disk drive, a hard disk drive control unit to control a spin-up operation of the hard disk drive, a controller to control operation of the hard disk drive and the hard disk drive control unit, and at least one interface to cause the controller to control operation of the hard disk drive and the hard disk drive control unit. The hard disk drive control unit may supply a first current to the hard disk drive to perform a first spin-up operation when a detected power level to the hard disk drive is a first level, and the hard disk drive control unit may supply a second current less than the first current to the hard disk drive to perform a second spin-up operation when a detected power level to the hard disk drive is a second level less than the first level.

The at least one interface may include a user interface to receive a user input to access the hard disk drive.

### BRIEF DESCRIPTION OF THE DRAWINGS

The above and other features and advantages of the present general inventive concept will become more apparent by describing in detail exemplary embodiments thereof with reference to the attached drawings in which:

FIGS. 1 and 2 are block diagrams of a storage device spin-up control system according to an embodiment of the present general inventive concept;

FIG. 3 is a block diagram of a power connector signal level detection unit of a host in FIG. 1, according to an embodiment of the present general inventive concept;

FIG. 4A is a timing diagram illustrating the level of a signal output from a power connector of an interface, and FIG. 4B is a timing diagram illustrating the level of a signal output from a power connector of an interface when spin-up current is controlled by the storage device spin-up control system of FIGS. 1 and 2;

FIG. 5A is a graph of current supplied to a storage device from a host with respect to time when a maximum current is greater than a threshold current, and FIG. 5B is a graph of current supplied to the storage device from the host with respect to time when the maximum current is less than the threshold current;

FIG. 6 is a block diagram of a storage device spin-up control system according to another embodiment of the present general inventive concept, wherein an automatic mode switching unit is further included;

FIG. 7 is a block diagram of a storage device spin-up control system according to another embodiment of the present general inventive concept, wherein a manual mode switching unit is further included;

FIG. 8 is a block diagram of a storage device spin-up control system according to another embodiment of the present general inventive concept, wherein an automatic mode switching unit and a manual mode switching unit are further included;

FIG. 9 is a block diagram of a storage device spin-up control system to control spin-up of a plurality of storage devices according to another embodiment of the present general inventive concept;

FIG. 10A is a timing diagram illustrating the level of a signal output from a power connector of an interface when spinning up a plurality of storage devices, and FIG. 10B is a timing diagram illustrating the level of a signal output from a power connector of an interface when spin-up current is controlled to spin up a plurality of storage device by the storage device spin-up control system of FIG. 9;

FIG. 11 is a block diagram of a storage device spin-up control system of controlling spin-up of a plurality of storage devices according to another embodiment of the present general inventive concept, wherein an automatic mode switching unit is further included in a host;

FIG. 12 is a block diagram of a storage device spin-up control system of controlling spin-up of a plurality of storage devices according to another embodiment of the present general inventive concept, wherein a manual mode switching unit is further included;

FIG. 13 is a block diagram of a storage device spin-up control system of controlling spin-up of a plurality of storage devices according to another embodiment of the present general inventive concept, wherein an automatic mode switching unit and a manual mode switching unit are further included;

FIG. 14 is a flowchart of a storage device spin-up control method according to an embodiment of the present general inventive concept;

FIG. 15 is a flowchart of a storage device spin-up control method of controlling spin-up of a plurality of storage devices according to another embodiment of the present general inventive concept;

FIG. 16 illustrates a storage device spin-up control system according to an embodiment of the present general inventive concept; and

FIG. 17 illustrates a computing device including a data storage device control unit according to an embodiment of the present general inventive concept.

### DETAILED DESCRIPTION OF THE EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

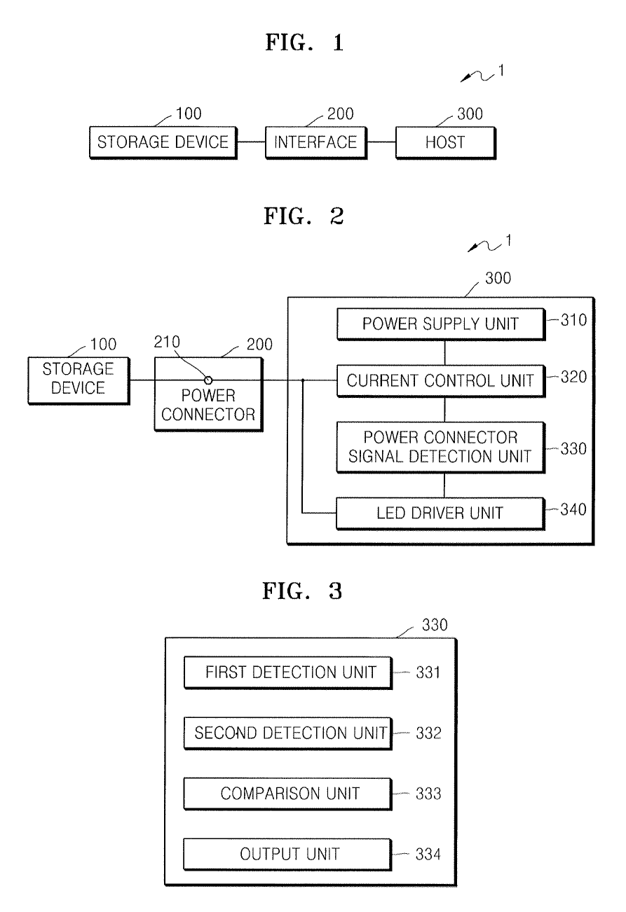

FIGS. 1 and 2 are block diagrams of a storage device spin-up control system 1 according to an embodiment of the present general inventive concept.

Referring to FIG. 1, the storage device spin-up control system 1 according to an embodiment of the present general inventive concept includes a storage device 100, an interface 200, and a host 300. The interface 200 links the storage device 100 and the host 300. The storage device 100 may be a hard disk drive. The interface 200 may be any point or terminal connecting the host 300 to the storage device 100, particularly along a power-supply path. The host 300 may include any type of host device, including a personal computer or terminal, a server, a functional component within a personal computer or server, a stand-alone device, or any other type of host device.

In the storage device spin-up control system 1, the host 300 controls a spin-up mode of the storage device 100 based on the level of a signal output from a power connector of the interface 200.

In particular, the storage device spin-up control system 1 determines whether to spin-up the storage device 100 in a normal current mode or to spin up the storage device 100 in a low current mode in which current level therein is lower than current level in the normal current mode according to the level of the signal output from the power connector of the interface 200.

Referring to FIG. 2, the power connector of the interface 200 may be a power connector 210. The host 300 includes a power supply unit 310, a current control unit 320, a power connector signal level detection unit 330, and a light-emitting diode (LED) driver unit 340.

The interface 200 may be a standard Advanced Technology Attachment (ATA) interface. ATA interfaces are standard interfaces to link storage devices such as personal computers (PCs), hard disks, and CD-ROM drives.

Alternatively, the interface 200 may be a Serial Advanced Technology Attachment (SATA) interface. SATA interfaces are computer buses designed to transfer data between storage devices and hosts, such as between the storage device 100 and the host 300, and particularly, are interfaces using serial encoding to increase data transfer rate.

The power connector 210 in the interface 200 may be a power pin 11, that is, one of power connectors used in an SATA interface. An SATA interface includes a plurality of power connectors. In general, the power pin 11 is used for staggered spin-up. However, in an embodiment of the present general inventive concept, the power pin 11 may be used to control current supplied from the host 300 to the storage device 100.

The power supply unit 310 supplies power to the storage device 100 via the power connector 210 of the interface 200 to spin-up the storage device 100.

The power connector signal level detection unit 330 detects the level of the signal output from the power connector 210 of the interface 200 and outputs a corresponding signal.

The current control unit 320 controls the spin-up mode of the storage device 100 based on the level of the signal output from the power connector signal level detection unit 330. In particular, the current control unit 320 spins up the storage device 100 in the normal current mode if the signal output from the power connector level detection unit 330 is at a first logic level, or spins up the storage device 100 in the low current mode if the signal output from the power connector level detection unit 330 is at a second logic level.

When the level of the signal output from the power connector 210 is at the first logic level, the level of the signal may be logic low. When the level of the signal output from the power connector 210 is at the second logic level, the level of the signal may be logic high.

The LED driver unit 340 indicates that the storage device 100 is in an active state when the storage device 100 has been successfully spun up using the power supplied from the host 300 and is ready for operation.

FIG. 3 is a block diagram of the power connector signal level detection unit 330 of the host 300 in FIG. 2, according to an embodiment of the present general inventive concept.

The power connector signal level detection unit 330 includes a first detection unit 331, a second detection unit 332, a comparison unit 333, and an output unit 334.

The first detection unit 331 detects a maximum current that can be supplied from the host 300 to spin up the storage device 100. The second detection unit 332 detects a threshold current required for the storage device 100 to spin up. The comparison unit 333 compares the maximum current detected by the first detection unit 331 and the threshold current detected by the second detection unit 332. The output unit 334 outputs a signal corresponding to the level of the signal of the power connector 210 at a first logic level if the maximum current is greater than the threshold current and outputs a signal corresponding to the level of the signal of the power connector 210 at a second logic level if the maximum current is less than the threshold current.

Referring back to FIG. 2, the current control unit 320 spins up the storage device 100 in the normal current mode if the signal output from the output unit 334 of the power connector level detection unit 330 is at the first logic level, and spins up the storage device 100 in the low current mode if the signal output from the output unit 334 of the power connector level detection unit 330 is at the second logic level.

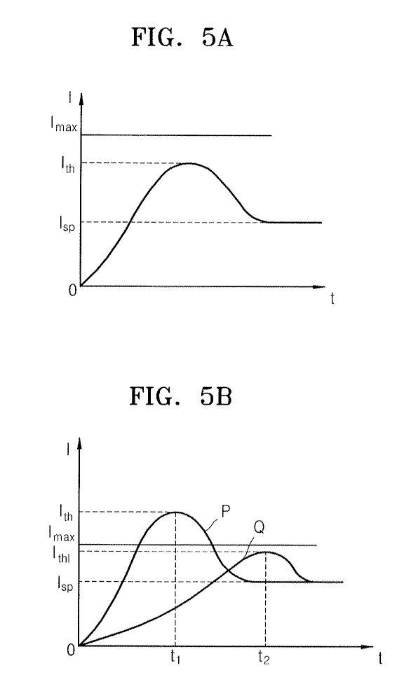

FIG. 5A is a graph of current supplied to the storage device 100 by the host 300 with respect to time when the maximum current is greater than the threshold current. FIG. 5B is a graph of current supplied to the storage device 100 by the host 300 with respect to time when the maximum current is less than the threshold current.

The storage device 100 may be successfully spun up when the storage device 100 receives a spin-up current greater than or equal to a threshold current Iₜₕ from the host 300. When a maximum current Iₘₐₓ that can be supplied to the storage device 100 by the host 300 is less than the threshold current Iₜₕ, the storage device 100 may fail to spin up.

When the maximum current Iₘₐₓ is greater than the threshold current Iₜₕ, as illustrated in FIG. 5A, the storage device 100 may be successfully spun up. In this case, the storage device 100 is spun up in the normal current mode. Once the storage device 100 has been successfully spun up, the host 300 continuously supplies a spin-up current Iₛₚ to the storage device 100 in order to maintain the storage device 100 in the spun up state.

However, when the maximum current Iₘₐₓ is less than the threshold current Iₜₕ, as illustrated by a plot P of FIG. 5B, the storage 100 may fail to spin up. In this case, the storage device 100 may be spun up in the low current mode, as in a plot Q of FIG. 5B.

Spinning up the storage device 100 in the low current mode implies controlling the threshold current Iₜₕ of the storage device 100 to be less than the maximum current Iₘₐₓ supplied from the host 300.

Comparing the plots P and Q, a threshold current Iₜₕₗ in the plot Q is less than the threshold current Iₜₕ in the plot P. In addition, a time t₂ at which the storage device 100 reaches the threshold current Iₜₕₗ in the plot Q is greater than a time t₁ at which the storage device 100 reaches the threshold current Iₜₕ in the plot P.

In other words, in the storage device spin-up control system 1 according to an embodiment of the present general inventive concept, when the threshold current Iₜₕ of the storage device 100 is greater than the maximum current Iₘₐₓ, the storage device 100 may not be successful in spinning up in the normal current mode, and thus the storage device 100 is controlled to spin up in the low current mode, such as in the case of the plot Q. The low-current mode may take longer to achieve an operating spin-up velocity, but it allows the storage device 100 to operate below the threshold current value Iₜₕ.

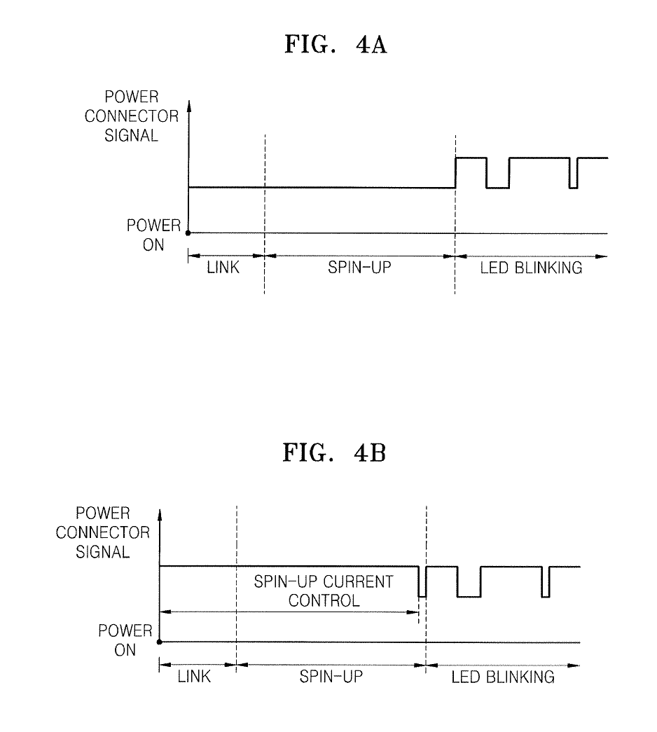

FIG. 4A is a timing diagram illustrating the level of a signal output from a power connector of an interface. FIG. 4B is a timing diagram illustrating the level of a signal output from the power connector 210 of the interface 200 when spin-up current is controlled by the storage device spin-up control system of FIGS. 1 and 2.

Referring to FIG. 4A, the power connector 210 is neither used in a link interval in which the storage device 100 and the host 300 are linked nor in a spin-up interval in which the storage device 100 is to be spun up, but is used in an LED blinking interval in which it may be indicated that the storage device 100 is in an active state.

However, referring to FIG. 4B, unlike the case of FIG. 4A, the power connector 210 is used in both the link interval in which the storage device 100 and the host 300 are linked, and the spin-up interval in which the storage device 100 is to be spun up, in order to control the spin-up current of the storage device 100.

The storage device spin-up control system 1 according to an embodiment of the present general inventive concept spins up the storage device 100 in the low current mode when the level of the signal output from the power connector 210 in the link interval and in the spin-up interval is output as logic high.

The storage device spin-up control system 1 according to an embodiment of the present general inventive concept spins up the storage device 100 in the normal current mode when the signal output from the power connector 210 is at a first logic level after the storage device 100 and the host 300 are linked, and spins up the storage device 100 in the low current mode when the signal output from the power connector 210 is at a second logic level after the storage device 100 and the host 300 are linked. The first logic level may be logic low, as illustrated in FIG. 4A. The second logic level may be logic high, as illustrated in FIG. 4B.

In other words, if signal output from the power connector 210 indicates that the host 300 may operate above a current threshold Iₜₕ, the output unit 334 of the power connector signal detection unit 330 may output a logic low signal during link and spin-up states, as illustrated in FIG. 4A. This may cause the current control unit 320 to output a spin-up signal according to a high-current, or normal-current mode, As illustrated in FIG. 5A. On the other hand, if signal output from the power connector 210 indicates that the host 300 may operate only below a current threshold Iₜₕ, the output unit 334 of the power connector signal detection unit 330 may output a logic high signal during link and spin-up states, as illustrated in FIG. 4B. This may cause the current control unit 320 to output a spin-up signal according to a low-current mode, as indicated by curve Q of FIG. 5B.

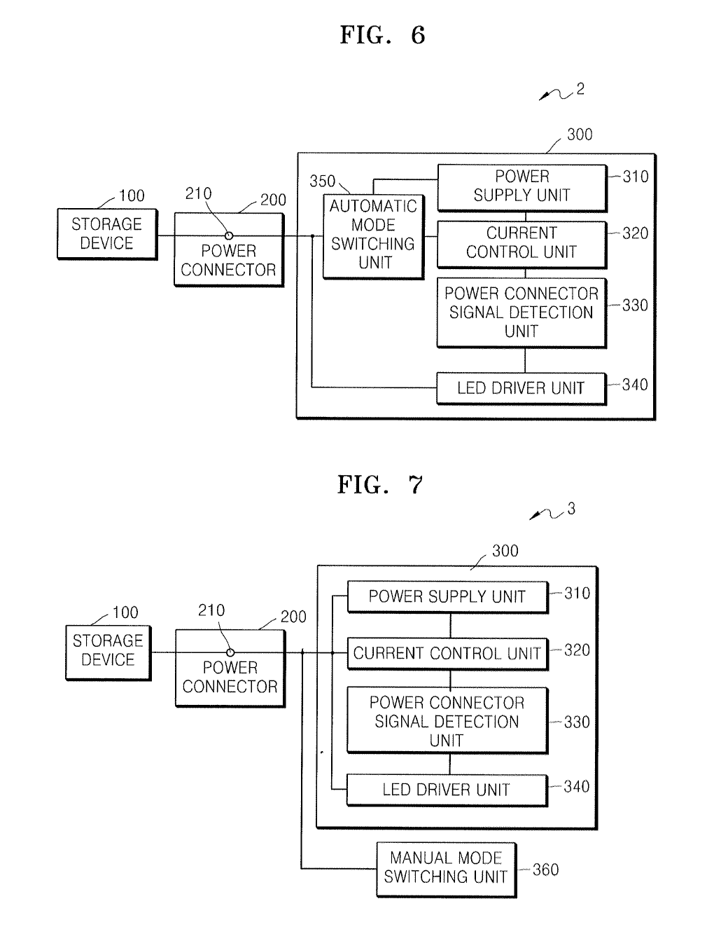

FIG. 6 is a block diagram of a storage device spin-up control system 2 according to another embodiment of the present general inventive concept, wherein an automatic mode switching unit 350 is further included.

Referring to FIG. 6, in the storage device spin-up control system 2 according to an embodiment, a host 300 includes a power supply unit 310, a current control unit 320, a power connector signal level detection unit 330, an LED driver unit 340, and the automatic mode switching unit 350.

In the storage device spin-up control system 1 illustrated in FIG. 3, the power control unit 320 controls current supplied to the storage device 100 from the power supply unit 310 of the host 300 based on the level of a signal output from the output unit 334 of the power connector signal level detection unit 330.

In the embodiment illustrated in FIG. 6, the automatic mode switching unit 350 is further included in the host 300, unlike the previous embodiment shown in FIG. 2. The automatic mode switching unit 350 performs controlling in such a way that the current control unit 320 and the power connector signal level detection unit 330 are not operated in an initial spin-up stage of the storage unit 100 and current is supplied from the power supply unit 310 to the storage unit 100.

The automatic mode switching unit 350 determines whether the storage device 100 has been successfully spun up by using the current supplied from the power supply unit 310 of the host 300. The automatic mode switching unit 350 performs controlling in such a way that the current control unit 320 and the power connector signal level detection unit 330 are not operated if the spinning up of the storage device 100 is successful and are operated if the storage device 100 fails to spin up. A method of controlling the spin-up mode of the storage device 100 by using the current control unit 320 and the power connector signal level detection unit 330 when the storage device 100 fails to spin up is the same as described above with reference to FIGS. 2 and 3.

FIG. 7 is a block diagram of a storage device spin-up control system 3 according to another embodiment of the present general inventive concept, wherein a manual mode switching unit 360 is further included.

The manual mode switching unit 360 is located outside the host 300. In the storage device spin-up control system 3 according to the embodiment illustrated in FIG. 7, the manual mode switching unit 360 is used to enable the host 300 to control the spin-up mode of the storage device 100 exclusively when the manual mode switching unit 360 is selected by a user.

In particular, when the manual mode switching unit 360 is not selected by the user, the host 300 spins up the storage device 100 in the normal current mode. When the manual mode switching unit 360 is selected by the user, the host 300 spins up the storage device 100 in the low current mode.

The manual mode switching unit 360 may be an external switch located outside the host 300, for example.

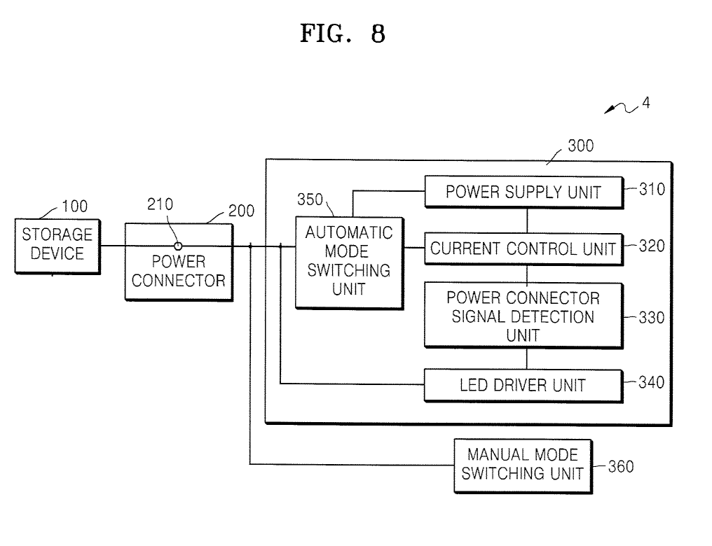

FIG. 8 is a block diagram of a storage device spin-up control system 4 according to another embodiment of the present general inventive concept, wherein an automatic mode switching unit 350 and a manual mode switching unit 360 are both connected to the power connector 210.

The storage device spin-up control system 4 according to an embodiment of the present general inventive concept includes both the automatic mode switching unit 350, which is located in the host 300, and the manual mode switching unit 360, which may be located outside the host 300.

The automatic mode switching unit 350 and the manual mode switching unit 360 are respectively described above with reference to FIGS. 6 and 7, and thus a detailed description thereof will not be provided here.

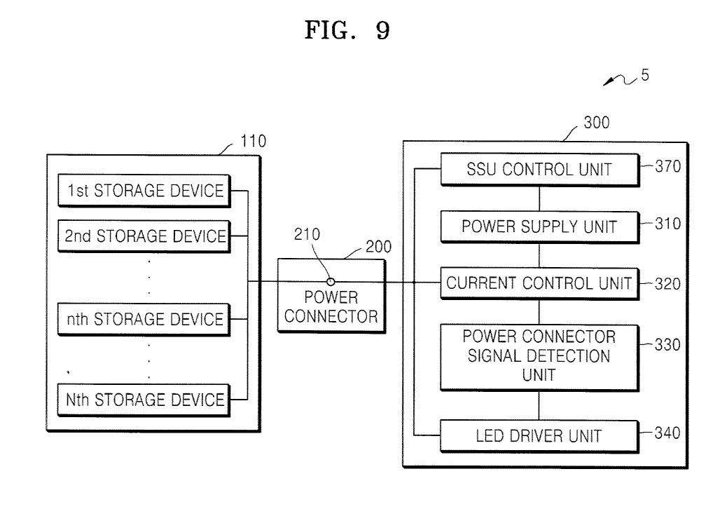

FIG. 9 is a block diagram of a storage device spin-up control system 5 to control spin-up of a plurality of storage devices according to another embodiment of the present general inventive concept.

Referring to FIG. 9, the storage device spin-up control system 5 includes a storage device unit 110 including N storage devices, wherein N is a natural number of 2 or greater, an interface 200 including a power connector 210, and a host 300. The host 300 controls spin-up mode of each of the N storage devices based on the level of a signal output from the power connector 210 of the interface 200.

The host 300 includes a power supply unit 310, a current control unit 320, a power connector signal level detection unit 330, an LED driver unit 340, and a staggered spin-up (SSU) control unit 370.

The SSU control unit 370 controls sequential spinning up of the N storage devices. For example, the SSU control unit 370 may control the spinning up of the storage devices in such a way that a 2^{nd} storage device is spun up a predetermined amount of time after a 1^{st} storage device has been spun up. Likewise, a 3^{rd} storage device is spun up a predetermined amount of time after the 2^{nd} storage device has been spun up.

The power connector signal level detection unit 330 detects the level of the signal output from the power connector 210 and outputs a corresponding signal.

The power connector signal level detection unit 330 has the same structure as illustrated in FIG. 3.

In particular, referring back to FIG. 3, the first detection unit 331 detects a maximum current that can be supplied from the host 300 to spin up the N storage devices. The second detection unit 332 detects a threshold current required for an n^{th} storage device to spin up, wherein n is a natural number from 1 to N, and the n^{th} storage device being one of the N storage devices.

The comparison unit 333 compares the maximum current detected by the first detection unit 331 and the threshold current required for the n^{th} storage device to spin up, which is detected by the second detection unit 332.

The output unit 334 outputs a signal corresponding to the level of the signal of the power connector 210 at a first logic level if the maximum current is greater than the threshold current required for the n^{th} storage device to spin up and outputs a signal corresponding to the level of the signal of the power connector 210 at a second logic level if the maximum current is less than the threshold current required for n^{th} storage device to spin up.

The current control unit 320 controls spin-up mode of the n^{th} storage device based on the level of the signal output from the output unit 334 of the power connector signal level detection unit 330.

In particular, the current control unit 320 spins up the n^{th} storage device in the normal current mode if the level of the signal output from the power connector level detection unit 330 is at the first logic level, and spins up the n^{th} storage device in the low current mode if the level of the signal output from the power connector level detection unit 330 is at the second logic level.

In the storage device spin-up control system 5, the interface 200 may be an SATA interface. The power connector 210 may be a power pin 11, that is, one of the power connectors used in an SATA interface.

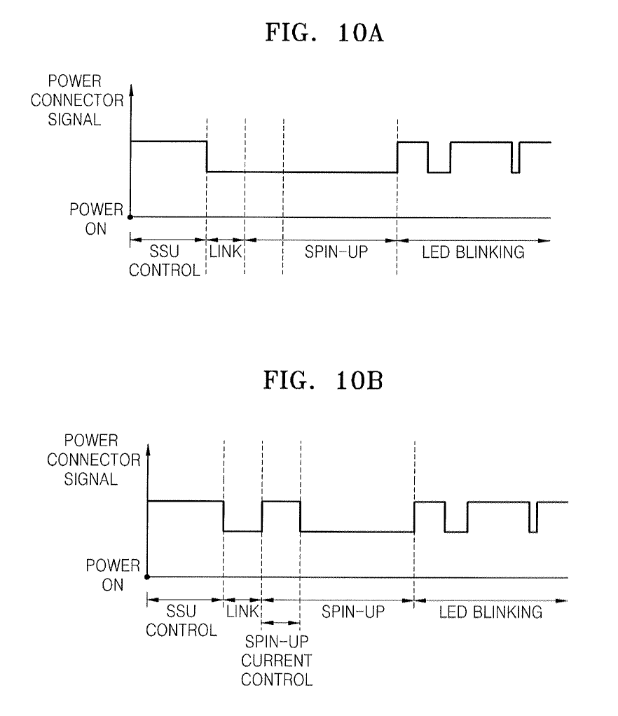

FIG. 10A is a timing diagram illustrating the level of a signal output from a power connector of an interface. FIG. 10B is a timing diagram illustrating the level of a signal output from the power connector 210 of the interface 200 when spin-up current is controlled to spin up the plurality of storage devices by the storage device spin-up control system of FIG. 9.

Referring to FIG. 10A, the signal output from the power connector 210 is logic high in an SSU control interval. Then, when the signal output from the power connector 210 becomes logic low, the n^{th} storage device and the host 300 are linked. The power connector 210 is not operated in a spin-up interval in which the n^{th} storage device is to be spun up, but is used in an LED blinking interval in which it may be indicated that the nth storage device is in an active state.

Referring to FIG. 10B, unlike the case of FIG. 10A, the power connector 210 is used in an initial stage of the spun-up interval in which the n^{th} storage device is to be spun up, in order to control spin-up current for the n^{th} storage device.

The storage device spin-up control system 1 to control spin-up of a plurality of storage devices according to an embodiment of the present general inventive concept spins up the n^{th} storage device 100 in the low current mode when the level of the signal output from the power connector 210 in the initial stage of the spin-up interval is output as logic high.

The storage device spin-up control system 5 to control spin-up of a plurality of storage devices according to an embodiment of the present general inventive concept spins up the n^{th} storage device 100 in the normal current mode when the level of the signal output from the power connector 210 is at a first logic level after the n^{th} storage device and the host 300 are linked and spins up the n^{th} storage device in the low current mode when the level of the signal output from the power connector 210 is at a second logic level after the n^{th} storage device and the host 300 are linked. The first logic level may be logic low, as illustrated in FIG. 10A. The second logic level may be logic high, as illustrated in FIG. 10B.

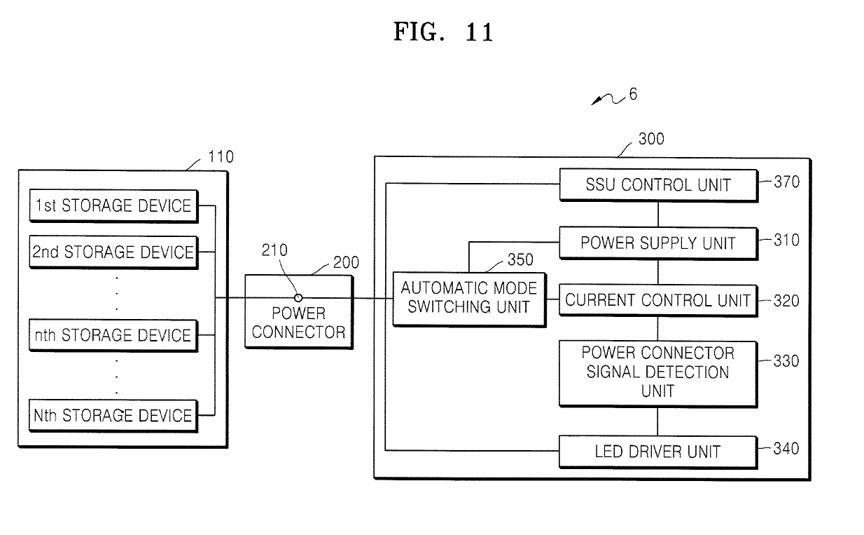

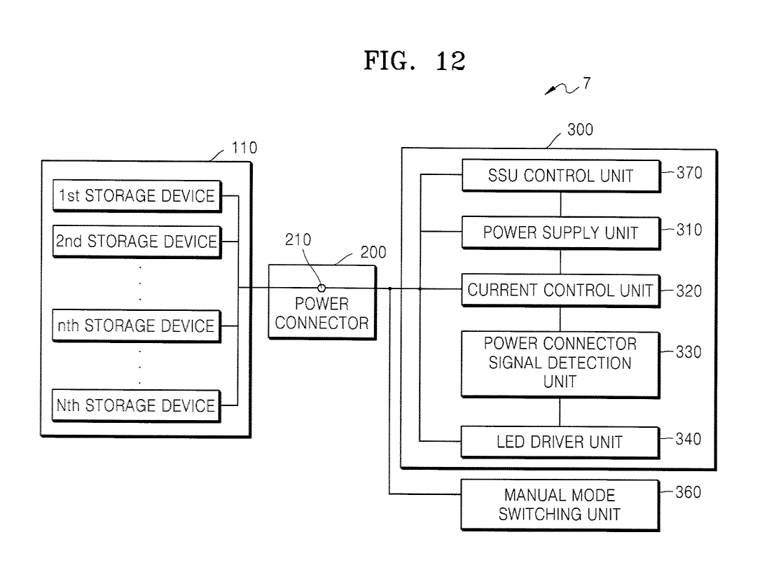

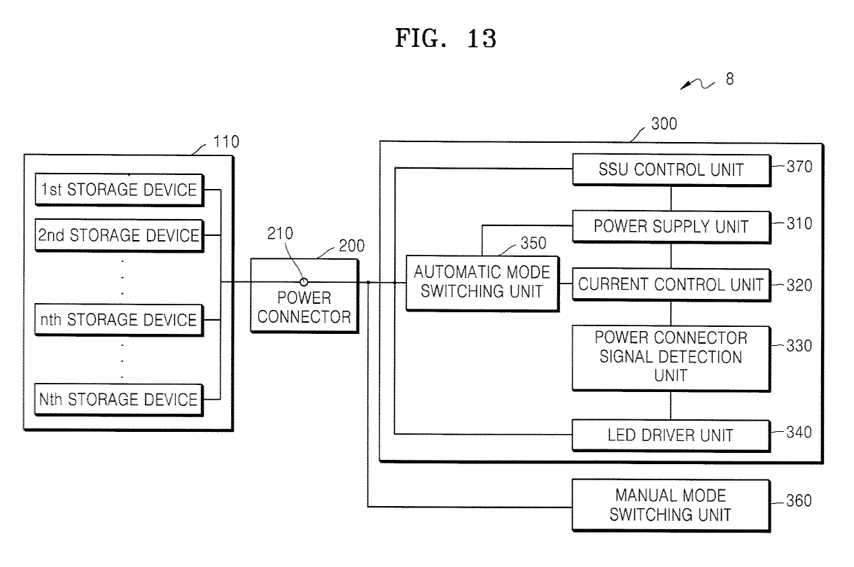

FIG. 11 is a block diagram of a storage device spin-up control system 6 to control spin-up of a plurality of storage devices, according to another embodiment of the present general inventive concept, wherein an automatic mode switching unit 350 is further included in a host 300.

Referring to FIG. 11, the host 300 includes a power supply unit 310, a current control unit 320, a power connector signal level detection unit 330, an LED driver unit 340, an SSU control unit 370, and the automatic mode switching unit 350.

As described in the previous embodiment with reference to FIG. 9, the power control unit 320 controls current supplied to the n^{th} storage device from the power supply unit 310 of the host 300 based on the level of a signal output from an output unit 334 (see FIG. 3) of the power connector signal level detection unit 330.

In an embodiment according to FIG. 11, the automatic mode switching unit 350 is further included in the host 300, unlike the previous embodiment described with reference to FIG. 9. The automatic mode switching unit 350 performs controlling in such a way that the current control unit 320 and the power connector signal level detection unit 330 are not operated in an initial spin-up stage of the n^{th} storage device and current is supplied from the power supply unit 310 to the n^{th} storage device in the initial spin-up stage.

The automatic mode switching unit 350 determines whether the n^{th} storage device has been successfully spun up by using the current supplied from the power supply unit 310 of the host 300. The automatic mode switching unit 350 performs controlling in such a way that the current control unit 320 and the power connector signal level detection unit 330 are not operated if the storage device 100 is successfully spun up, and are operated if the storage device 100 fails to spin up. A method of controlling the spin-up mode of the n^{th} storage device by using the current control unit 320 and the power connector signal level detection unit 330 when the storage device 100 fails to spin up is the same as described above with reference to FIG. 9.

FIG. 12 is a block diagram of a storage device spin-up control system 7 to control spin-up of a plurality of storage devices, according to another embodiment of the present general inventive concept, wherein a manual mode switching unit 360 is further included.

The manual mode switching unit 360 is located outside the host 300. In the storage device spin-up control system 7 according to an embodiment, the manual mode switching unit 360 is used to enable the host 300 to control the spin-up mode of a storage device unit 110 exclusively when the manual mode switching unit 360 is selected by a user. In particular, when the manual mode switching unit 360 is not selected by the user, the host 300 spins up the n^{th} storage device in a normal current mode. When the manual mode switching unit 360 is selected by the user, the host 300 spins up the n^{th} storage device in a low current mode.

The manual mode switching unit 360 may be an external switch located outside the host 300.

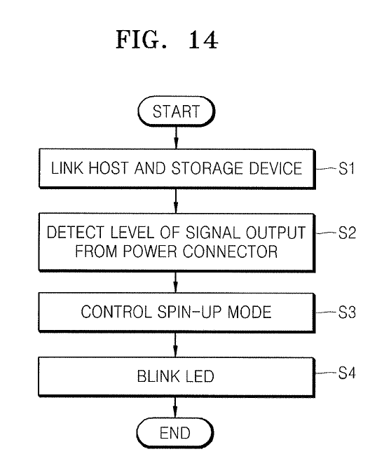

FIG. 13 is a block diagram of a storage device spin-up control system 8 to control spin-up of a plurality of storage devices according to another embodiment of the present general inventive concept, wherein an automatic mode switching unit 350 and a manual mode switching unit 360 are both included.

The storage device spin-up control system 8 as illustrated in FIG. 13 includes both the automatic mode switching unit 350, which is located in the host 300, and the manual mode switching unit 360, which is located outside the host 300.

The automatic mode switching unit 350 and the manual mode switching unit 360 are respectively described above with reference to FIGS. 11 and 12, and thus a detailed description thereof will not be provided here.

FIG. 14 is a flowchart of a storage device spin-up control method according to an embodiment of the present general inventive concept.

With reference to the storage device spin-up control systems 1 to 4 of FIGS. 2, 6, 7 and 8, in order to supply spin-up current from the host 300 to the storage device 100, the host 300 and the storage device 100 are linked via the interface 200 (operation S1).

The power connector signal level detection unit 330 in the host 300 detects the level of a signal output from the power connector 210 of the interface 200 linking the host 300 and the storage device 100 and outputs a corresponding signal (operation S2).

Operation S2 involves detecting a maximum current that can be supplied from the host 300 to spin up the storage device 100, detecting a threshold current required for the storage device 100 to spin up, comparing the maximum current and the threshold current, and outputting a signal corresponding to the level of the signal of the power connector at a first logic level if the maximum current is greater than the threshold current and outputting a signal corresponding to the level of the signal of the power connector at a second logic level if the maximum current is less than the threshold current.

The current control unit 320 in the host 300 controls a spin-up mode of the storage device 100 based on the detected level of the signal output from the power connector 210.

In operation S3 of controlling a spin-up mode of the storage device 100, the host 300 spins up the storage device 100 in a normal current mode if the level of the signal output from the power connector 210 is at the first logic level, and spins up the storage device 100 in a low current mode if the level of the signal output from the power connector 210 is the second logic level.

In an embodiment, the first logic level may be logic low, and the second logic level may be logic high.

The LED driver unit 340 in the host 300 blinks an LED when the storage device 100 has been successfully spun up using the power supplied from the host 300 and when the storage device 100 is ready for operation.

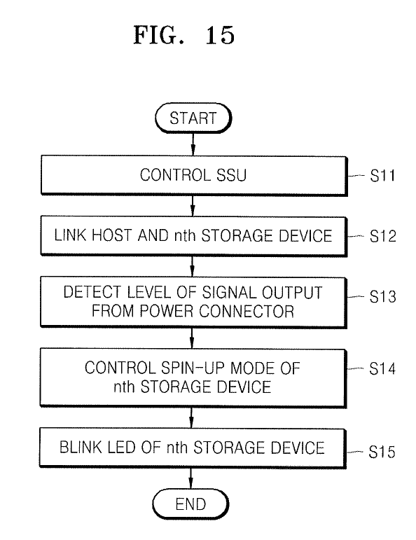

FIG. 15 is a flowchart of a storage device spin-up control method of controlling spin-up of a plurality of storage devices, according to another embodiment of the present general inventive concept.

In the storage device spin-up control method according to FIG. 15, spin-up modes of N storage devices, where N is a natural number of 2 or greater, are sequentially controlled based on the level of a signal output from the power connector 210 of the interface 200.

The SSU control unit 370 in the host 300 controls the N storage devices to be sequentially spun up (operation S11). In order to supply a spin-up current from the host 300 to a n^{th} storage device, the host 300 and the n^{th} storage device, where n is a natural number from 1 to N, are linked via the interface 200 (operation S12).

The power connector signal level detection unit 330 in the host 300 detects the level of a signal output from the power connector 210 of the interface 200 and outputs a corresponding signal (operation S13).

Operation S2 involves detecting a maximum current that can be supplied from the host 300 to spin up the N storage devices, detecting a threshold current required for the n^{th} storage device to spin up, comparing the maximum current and the threshold current, and outputting a signal corresponding to the level of the signal output from the power connector at a first logic level if the maximum current is greater than the threshold current required for the n^{th} storage device to spin up and outputting a signal corresponding to the level of the signal of the power connector at a second logic level if the maximum current is less than the threshold current required for the n^{th} storage device to spin up.

The current control unit 320 in the host 300 controls a spin-up mode of the n^{th} storage device based on the detected level of the signal output from the power connector 210 (operation S14).

In operation S14 of controlling a spin-up mode of the n^{th} storage device, the host 300 spins up the n^{th} storage device in a normal current mode if the level of the signal output from the power connector 210 is at the first logic level, and spins up the n^{th} storage device in a low current mode if the level of the signal of the power connector 210 is at the second logic level.

The first logic level may be logic low and the second logic level may be logic high, for example.

The LED driver unit 340 in the host 300 blinks an LED when the n^{th} storage device has been successfully spun up by using the power supplied from the host 300 and is ready for operation.

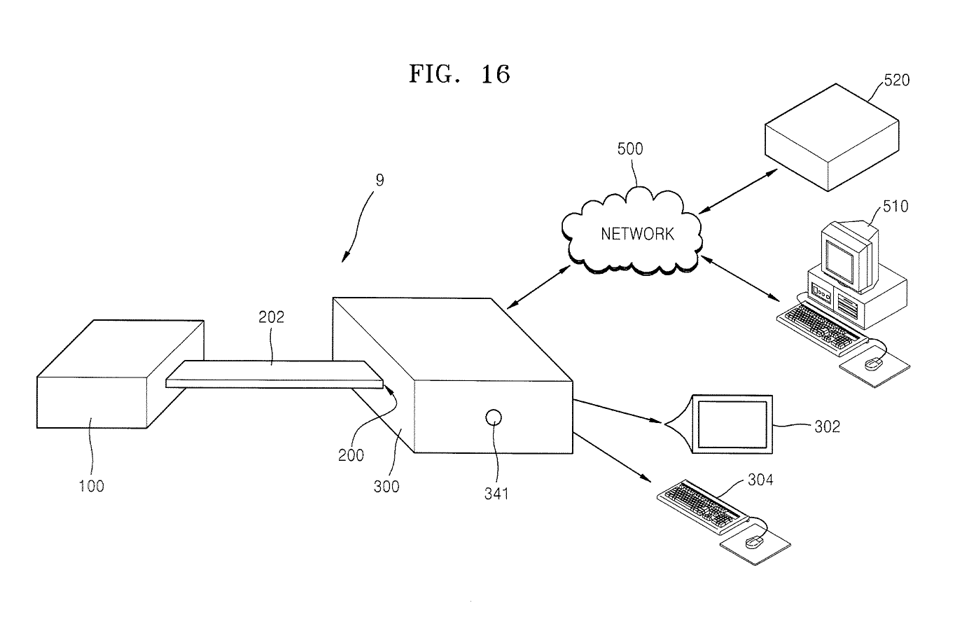

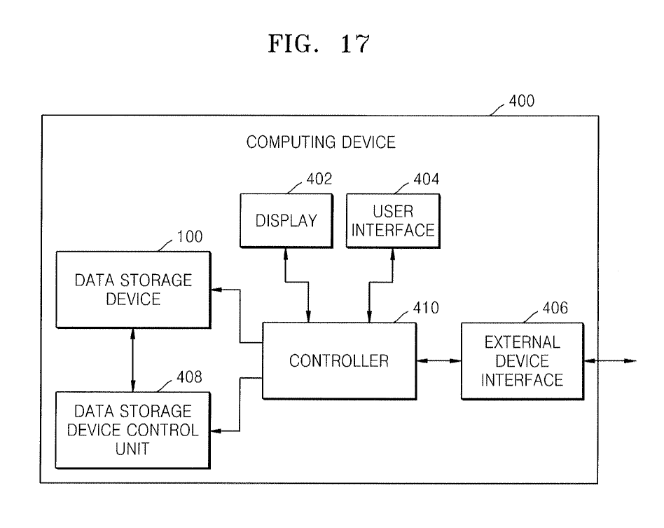

FIG. 16 illustrates an example of a storage-device spin-up control system 9 according to an embodiment of the present general inventive concept. The system 9 may include the storage device 100 connected via a cable or other connector 202 to a host device 300. The cable 202 may be connected to the host device 300 via an interface 200, for example. As illustrated in FIG. 16, the storage device 100 and host device 300 may be separate devices having separate frames or covers. The host device 300 may include the power supply unit 310, current control unit 320, power connector signal detection unit 330, and LED driver unit 340 illustrated in FIG. 2. The LED driver unit 340 may drive an LED 341 to illuminate when the host device 300 accesses or controls the storage unit 100, for example.

The host device 300 may be a personal computer or terminal, and it may be directly connected to a display 302 and a user interface 304 to allow a user to operate the host device 300. The host device 300 may be connected via a wired or wireless network 500 to a user terminal or PC 510 or another host device 520 or external device to control the host device 300.

FIG. 17 illustrates a computing device 400 according to an embodiment of the present general inventive concept in which the storage device, or data storage device, 100 and the host device 300 are part of the computing device 400. The computing device 400 may include a display 402 to display data, a user interface 404 to allow a user to interact with the display 402 to control the computing device 400, and an external device interface 406 to transmit and/or receive data to/from external devices. The display 402 may be a CRT monitor, an LED display, an LCD display, or any other type of display. The user interface 404 may be a keyboard, mouse, keypad, touch-screen, or any other type of user interface. The external device interface 406 may include wired ports and/or a wireless transceiver.

The data storage device 100 may be a hard disk drive, for example. A data storage device control unit 408 may control power supplied to the data storage device. The data storage device control unit 408 may correspond to the host unit 300 of FIG. 2, for example. A controller 410 may control operation of the computing device 400 including the data storage device 100 and the data storage device control unit 408. The controller 410 may include one or more processors, memory, and logic to control operation of the computing device 400.

The functional units of the host 300 may also be included in a same device as the data storage device 100. In other words, a single data storage device 100 may include a hard disk drive, a power supply unit, a current control unit, a power connector signal detection unit, and an LED driver unit. The combination of the hard disk drive and the host may be called a data storage device and may be included within a single frame, case, or cover. Operation of the combined storage device 100 and host 300 may be similar to the operation described above, with respect to FIGS. 1-15. In such a case, the power connector 210 may be a terminal of a cord or cable, a location on a wire or wiring on a printed circuit board, or any other point along an electrical path of the power supplied from the host 300 to the storage device 100.

As described above, according to the one or more of the above embodiments of the present general inventive concept, a spin-up mode of a storage device is selectively controlled based on the level of a signal output from a power connector of an interface connecting a host and the storage device. Thus, spin-up failure of the storage device caused due to insufficient power from the host may be prevented.

While the present general inventive concept has been particularly shown and described with reference to exemplary embodiments thereof, it will be understood by those of ordinary skill in the art that various changes in form and details may be made therein without departing from the spirit and scope of the present general inventive concept as defined by the following claims.

What is claimed is:

1. A storage device spin-up control system comprising:
a storage device to store data;
a host to selectively control a spin-up mode of the storage device; and
an interface to link the storage device and the host,
wherein the host controls the spin-up mode of the storage device based on a level of a signal output from a power connector of the interface.

2. The storage device spin-up control system of claim 1, wherein the host comprises:
a power connector signal level detection unit that detects the level of the signal output from the power connector and outputs a corresponding signal.

3. The storage device spin-up control system of claim 2, wherein the host comprises:
a current control unit that controls the spin-up mode of the storage device based on the level of the signal detected by the power connector signal level detection unit.

4. The storage device spin-up control system of claim 3, wherein the current control unit spins up the storage device in a normal current mode if the signal output from the power connector level detection unit is at a first logic level and spins up the storage device in a low current mode if the signal output from the power connector level detection unit is at a second logic level.

5. The storage device spin-up control system of claim 2, wherein the power connector signal level detection unit comprises:
a first detection unit to detect a maximum current that can be supplied from the host to spin up the storage device;
a second detection unit to detect a threshold current required for the storage device to spin up;
a comparison unit to compare the maximum current detected by the first detection unit and the threshold current detected by the second detection unit; and
an output unit to output a signal corresponding to the level of the signal of the power connector at a first logic level if the maximum current is greater than the threshold current and outputting a signal corresponding to the level of the signal of the power connector at a second logic level if the maximum current is less than the threshold current.

6. The storage device spin-up control system of claim 1, wherein the host comprises an automatic mode switching unit that determines whether the storage device has been successfully spun up by using a current supplied from a power supply unit of the host and performs controlling on the spin-up mode of the storage device based on the level of the signal output from the power connector exclusively when the storage device fails to spin up.

7. The storage device spin-up control system of claim 1, further comprising:
a manual mode switching unit,
wherein the host controls the spin-up mode of the storage device based on the level of a signal output from the power connector of the interface only when the manual mode is selected via the manual mode switching unit.

8. The storage device spin-up control system of claim 7, wherein the host spins up the storage device in a normal current mode if the manual mode switching unit is not selected by the user, and the host spins up the storage device in a low current mode if the manual mode switching unit is selected by the user.

9. The storage device spin-up control system of claim 7, wherein the manual mode switching unit comprises:
an external switch located outside the host.

10. The storage device spin-up control system of claim 1, wherein the interface comprises:
a Serial Advanced Technology Attachment (SATA) interface, and
the power connector comprises a power pin 11 of the SATA interface.

11. A storage device spin-up control system comprising:
N storage devices to store data, where N is a natural number of 2 or greater;
a host to selectively control spin-up modes of the N storage devices; and
an interface to link the N storage devices and the host,
wherein the host comprises a staggered spin-up (SSU) control unit to sequentially control spinning up of the N storage devices, and
the host controls the spin-up modes of the N storage devices based on a level of a signal output from a power connector of the interface.

12. The storage device spin-up control system of claim 11, wherein the host comprises:
a power connector signal level detection unit that detects the level of the signal output from the power connector and outputs a corresponding signal.

13. The storage device spin-up control system of claim 12, wherein the host comprises:
a current control unit that controls a spin-up mode of an n^{th} storage device based on the level of the signal detected by the power connector signal level detection unit,
wherein n is a natural number from 1 to N used to denote one of the N storage devices.

14. The storage device spin-up control system of claim 13, wherein the current control unit spins up the n^{th} storage device in a normal current mode if the signal output from the power connector level detection unit is at a first logic level and spins up the n^{th} storage device in a low current mode if the signal output from the power connector level detection unit is at a second logic level.

15. A storage device spin-up control method comprising:
linking a host and a storage device;
detecting a level of a signal output from a power connector of an interface linking the host and the storage device; and
controlling a spin-up mode of the storage device based on the detected level of the signal.

16. The storage device spin-up control method of claim 15, wherein the controlling of the spin-up mode of the storage device comprises:
spinning up the storage device in a normal current mode if the signal output from the power connector is at a first logic level; and
spinning up the storage device in a low current mode if the signal output from the power connector is at a second logic level.

17. The storage device spin-up control method of claim 15, wherein the detecting of the level of the signal comprises:
detecting a maximum current that can be supplied from the host to spin up the storage device;
detecting a threshold current required for the storage device to spin up;
comparing the maximum current and the threshold current; and
outputting a signal corresponding to the level of the signal output from the power connector at a first logic level if the maximum current is greater than the threshold current and outputting a signal corresponding to the level of the signal output from the power connector at a second logic level if the maximum current is less than the threshold current.

18. A storage device spin-up control method comprising:
controlling sequential spinning up of N storage devices, where N is a natural number of 2 or greater;
linking a host and an n^{th} storage device, where the n^{th} storage device is one of the N storage devices and n is a natural number from 1 to N;
detecting a level of a signal output from a power connector of an interface linking the host and the N storage devices; and
controlling a spin-up mode of the n^{th} storage device based on the detected level of the signal.

19. The storage device spin-up control method of claim 18, wherein the controlling of the spin-up mode of the n^{th} storage device comprises:
spinning up the nth storage device in a normal current mode if the signal output from the power connector is at a first logic level and spinning up the n^{th} storage device in a low current mode if the signal output from the power connector is a second logic level.

20. The storage device spin-up control method of claim 18, wherein the detecting of the level of the signal comprises:
detecting a maximum current that can be supplied from the host to spin up the N storage devices;
detecting a threshold current required for the n^{th} storage device of the N storage devices to spin up;
comparing the maximum current and the threshold current of the n^{th} storage device; and
outputting a signal corresponding to the level of the signal output from the power connector at a first logic level if the maximum current is greater than the threshold current required for the n^{th} storage device to spin up and outputting a signal corresponding to the level of the signal of the power connector at a second logic level if the maximum current is less than the threshold current required for the n^{th} storage device to spin up.

21. A data storage device, comprising:
a hard disk drive; and
a hard disk drive control unit to control a spin-up operation of the hard disk drive,
wherein the hard disk drive control unit supplies a first current to the hard disk drive to perform a first spin-up operation when a detected power level to the hard disk drive is a first level, and
the hard disk drive control unit supplies a second current less than the first current to the hard disk drive to perform a second spin-up operation when a detected power level to the hard disk drive is a second level less than the first level.

22. The data storage device according to claim 21, wherein the hard disk drive control unit comprises:
a power supply unit to supply power to the hard disk drive to perform the spin-up operation;
a current control unit to supply the first and second current to the hard disk drive; and
a power level detection unit to detect the power level supplied to the hard disk drive.

23. The data storage device according to claim 22, wherein the power level detection unit comprises:
a first detection unit to detect a threshold current level required by the hard disk drive to perform the first spin-up operation;
a second detection unit to detect the power level supplied to the hard disk drive;
a comparison unit to compare a power level corresponding to the current level detected by the first detection unit and the power level supplied to the hard disk drive; and
an output unit to output a power level detection signal to the current control unit.

24. The data storage device according to claim 23, wherein the output unit outputs the power level detection signal on a connection pin of the hard disk drive control unit that is used to control a staggered spin-up of the hard disk drive.

25. A computing device, comprising:
a hard disk drive;
a hard disk drive control unit to control a spin-up operation of the hard disk drive;
wherein the hard disk drive control unit supplies a first current to the hard disk drive to perform a first spin-up operation when a detected power level to the hard disk drive is a first level, and
the hard disk drive control unit supplies a second current less than the first current to the hard disk drive to perform a second spin-up operation when a detected power level to the hard disk drive is a second level less than the first level.

26. The computing device according to claim 25, further comprising:
a controller to control operation of the hard disk drive and the hard disk drive control unit; and
at least one interface to cause the controller to control operation of the hard disk drive and the hard disk drive control unit,

27. The computing device according to claim 26, wherein the at least one interface includes a user interface to receive a user input to access the hard disk drive.
